(19) United States
(12) Patent Application Publication
(10) Pub. No.: US 2017/0217128 A1
(43) Pub. Date: Aug. 3, 2017

(54) COMPOSITE HOLLOW BOARD STRUCTURE AND MANUFACTURING METHOD THEREOF

(71) Applicants: Hsuan-Chih LIN, New Taipei City (TW); Chun-Cheng LEE, Taichung City (TW)

(72) Inventors: Hsuan-Chih LIN, New Taipei City (TW); Chun-Cheng LEE, Taichung City (TW)

(21) Appl. No.: 15/416,099

(22) Filed: Jan. 26, 2017

(30) Foreign Application Priority Data
Feb. 3, 2016 (TW) 105103635

(51) Int. Cl. B32B 7/08; B32B 37/10; B32B 3/30; B32B 7/04; B32B 3/26

(52) U.S. Cl. CPC B32B 7/08; B32B 7/045; B32B 3/266; B32B 3/30; B32B 37/10; B32B 2307/718; B32B 2307/54; B32B 2307/558

(57) ABSTRACT

A composite hollow board structure and a manufacturing method thereof are provided. The composite hollow board structure includes a first plate having a surface formed of a plurality of first conical rings and a plurality of first attachment rings thereon; and a second plate pressed onto the first plate and having a surface formed a plurality of second conical rings and a plurality of second attachment rings thereon; wherein each first conical ring and each second attachment ring are inserted onto each other, each second conical ring and each first attachment ring are inserted onto each other; a hollow cavity is respectively formed between each first conical ring and each second attachment ring as well as between each second conical ring and each first attachment ring. Accordingly, the known bonding or welding step can be omitted to increase deformation capacity with simplified process and reduced manufacturing time.

### BACKGROUND OF THE INVENTION

Field of the Invention

The present invention is related to a bonding technique of a composite material, in particular, to a composite hollow board structure and a manufacturing method thereof.

Description of Related Art

With the continuous advancement and development of technologies, the application of composite materials to various products is common, including the products of the chassis of mobile phones, tablet computers, notebook computers and mechanical accessories thereof, fan blades, automobile parts, medical devices, home appliance housing or components, safety helmets, automobile body kits and internal parts, airplane interior and exterior parts, propellers, general vessel hull parts, military helmets, bullet-proof wearables, bathroom equipment, building materials etc. The products made from such material are not only of the merits of light weight, slim in size and appealing appearance, but also capable of effectively reducing the leakage of electromagnetic waves.

With the utilization of the advantages of light weight and pressure resistance of composite materials, a honeycomb board has been developed and available in the market. Such honeycomb board mainly bonds or welds two relatively thin panels together onto two sides of a relatively thicker honeycomb core material in order to form the board. The honeycomb core material is typically a core of hexagonal hollow structure of a honeycomb shape and soaked with synthetic resin, such as phenol and polyester, bonded between two plates.

Nevertheless, the aforementioned known honeycomb board is of the following drawbacks. Since the two side plates use the method of bonding or welding to attach onto the two sides of the honeycomb core material, only a tiny amount of deformation is tolerated on the honeycomb board. If the honeycomb board is overly bent to cause an excessive deformation, the bonding or welding parts would be separated or ruptured, causing damages or breakage of the honeycomb board. Accordingly, it is a key for manufacturers to create a composite material having the advantageous properties of light weight, pressure resistance and bending resistance.

In view of the drawbacks associated with the currently existing known art, it is an objective of the inventor of the present invention to provide a solution capable of overcoming the aforementioned problems through years of research along with the utilization of theoretical principles.

### SUMMARY OF THE INVENTION

One of the objectives of the present invention is to provide a composite hollow board structure and a manufacturing process thereof, which is capable of manufacturing a composite hollow board without the use of the known bonding or welding method while increasing the deformation capacity, such as the resistance to bending, of the composite hollow board and simplifying the manufacturing process as well as reducing the manufacturing time.

To achieve the aforementioned objective, the present invention provides a manufacturing method for a composite hollow board structure, comprising the steps of: a) performing a formation process on a surface of a first plate to form a plurality of first conical rings and a plurality of first attachment rings thereon; b) performing a formation process on a surface of a second plate to form a plurality of second conical rings and a plurality of second attachment rings thereon; c) stacking the second plate onto the first plate by arranging each one of the first conical rings opposite from each one of the second attachment rings with each other respectively, and arranging each one of the second conical rings opposite from each one of the first attachment rings with each other respectively; and d) using a pressing device to perform a press process on the first plate and the second plate in order to allow each one of the first conical rings and each one of the second attachment rings to be inserted onto each other for attachment as well as to allow each one of the second conical rings and each one of the first attachment rings to be inserted onto each other for attachment, and a hollow cavity is respectively formed between each one of the first conical rings and each one of the second attachment rings as well as between each one of the second conical rings and each one of the first attachment rings.

To achieve the aforementioned objective, the present invention provides a manufacturing method for a composite hollow board structure, comprising the steps of: e) performing a formation process on two opposite surfaces of a first plate to form a plurality of first conical rings and a plurality of first attachment rings thereon; f) performing a formation process on a surface of a second plate to form a plurality of second conical rings and a plurality of second attachment rings thereon; g) performing a formation process on a surface of a third plate to form a plurality of third conical rings and a plurality of third attachment rings thereon; h) stacking the second plate and the third plate onto the two sides of the first plate by arranging each one of the first conical rings opposite from each one of the second attachment rings and each one of the third attachment rings with each other respectively, and arranging each one of the second conical rings and each one of the third conical rings opposite from each one of the first attachment rings with each other respectively; and i) using a pressing device to perform a press process on the first plate, the second plate and the third plate in order to allow each one of the first conical rings to and each one of the second and third attachment rings to be inserted onto each other for attachment as well as to allow each one of the second and third conical rings and each one of the first attachment rings to be inserted onto each other for attachment, and a hollow cavity is respectively formed between each one of the first conical rings and each one of the second and third attachment rings as well as between each one of the second and third conical rings and each one of the first attachment rings.

To achieve the aforementioned objective, the present invention provides a composite hollow board structure, comprising: a first plate having a surface formed of a plurality of first conical rings and a plurality of first attachment rings thereon; and a second plate pressed onto the first plate and having a surface formed a plurality of second conical rings and a plurality of second attachment rings thereon; and wherein each one of the first conical rings and each one of the second attachment rings are inserted onto each other for attachment, each one of the second conical rings and each one of the first attachment rings are inserted onto each other for attachment; wherein a hollow cavity is respectively formed between each one of the first conical rings and each one of the second attachment rings as well as between each one of the second conical rings and each one of the first attachment rings.

The present invention is also of the following technical effects. By using the shapes of conical rings, such rings can be inserted into the attachment rings with ease in order to form a press-fitted riveting structure, which is capable of withstanding vibrations, impacts and conditions of thermal expansion and contraction while preserving the toughness and integrity of the entire structure. Furthermore, the use of the conical ring shapes allows further gradual expansion of such conical rings inside the attachment rings after the inversion in order to significantly reduce the existence of any gaps therein such that the bonding strength between the first and second plates can be increased. Moreover, the manufacturing process of the present invention can expedite the mass production process with a great amount of cost reduction in addition to the merits of the finished product having the advantageous properties of slim, light weight, pressure resistant, bendable with deformation, high toughness, appealing appearance and facilitated formation process etc.

### BRIEF DESCRIPTION OF DRAWING

FIG. 1 is a flow chart of a manufacturing method for a composite hollow board structure of the present invention;

FIG. 2 is a perspective view of the first plate of the present invention;

FIG. 3 is a perspective enlarged view of the dashed-line area of the present invention in FIG. 2;

FIG. 4 is top enlarged view of the dashed-line area of the present invention in FIG. 2;

FIG. 5 is a cross sectional view of the first plate of the present invention;

FIG. 6 is a perspective view of the second plate of the present invention;

FIG. 7 is a perspective enlarged view of the dashed-line area of the present invention in FIG. 6;

FIG. 8 is top enlarged view of the dashed-line area of the present invention in FIG. 6;

FIG. 9 is a cross sectional view of the second plate of the present invention;

FIG. 10 is an illustration showing the second plate stacked onto the first plate of the present invention;

FIG. 11 is an illustration showing a press process performed by a pressing device on the first plate and the second plate;

FIG. 12 is a cross sectional assembly view of the composite hollow board structure of the present invention;

FIG. 13 is a flow chart of another embodiment of a manufacturing method for a composite hollow board structure of the present invention;

FIG. 14 is an illustration showing the second plate and the third plate stacked onto the first plate;

FIG. 15 is a cross sectional assembly view of another embodiment of the composite hollow board structure of the present invention;

FIG. 16 is a partially enlarged perspective view of another embodiment of the first plate of the present invention; and

FIG. 17 is a partially enlarged perspective view of another embodiment of the second plate of the present invention.

### DETAILED DESCRIPTION OF THE INVENTION

The following provides a detailed description on the present invention and the technical content thereof along with the accompanied drawings. However, it shall be understood that the accompanied drawings are provided for reference and illustrations only such that they shall not be used as limitations of the present invention.

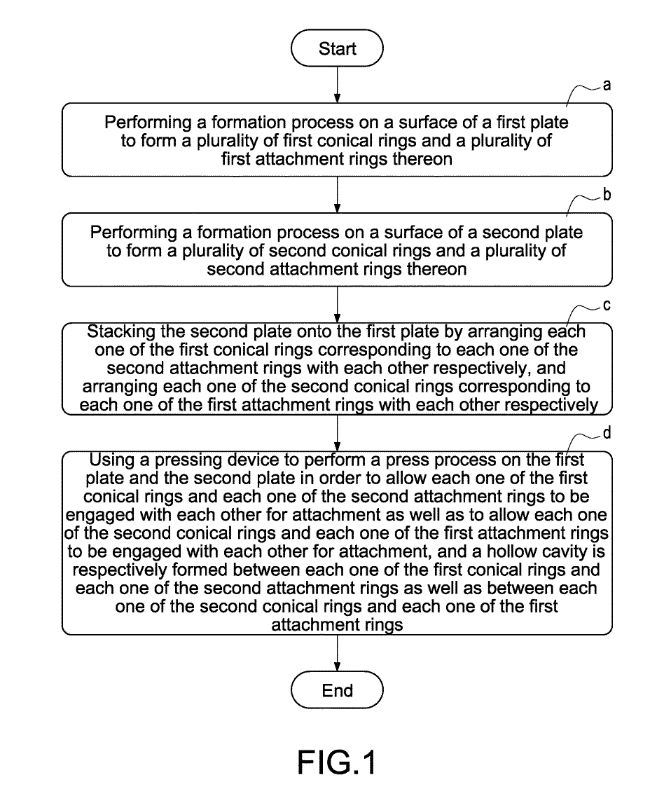

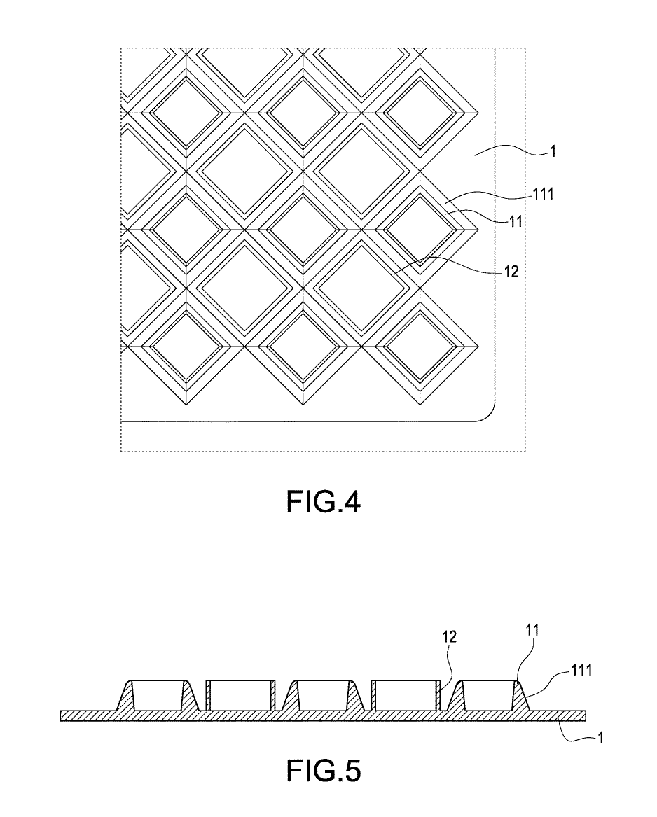

As shown in FIG. 1 to FIG. 12, the present invention provides a composite hollow board structure and a manufacturing method thereof. The following provides a detailed description on the steps of the method.

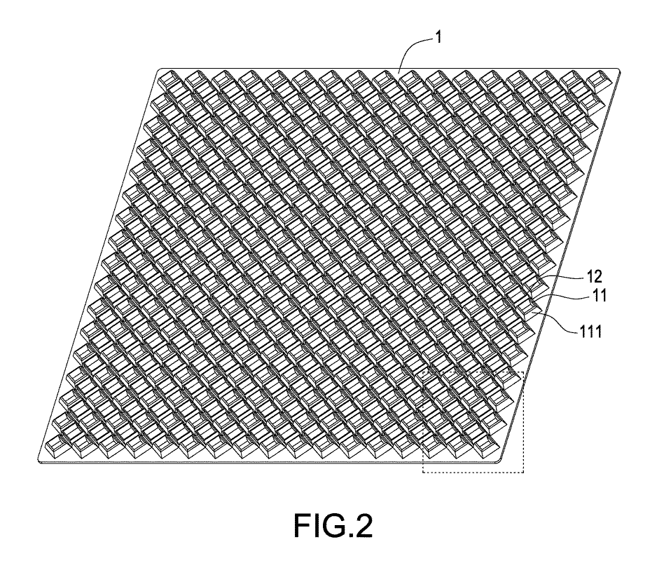

As shown in Step a in FIG. 2 and FIGS. 2 to 5, in Step a, a formation process is performed on a surface of a first plate 1 to form a plurality of first conical rings 11 and a plurality of first attachment rings 12. The first plate 1 can be a plate made of a metal material of stainless steel, copper alloy, aluminum alloy, magnesium alloy, aluminum-magnesium alloy etc. or a plastic material of PC, ABS, PP etc. In addition, the aforementioned formation process can be achieved by the rolling, impacting, laser or in-mold formation method etc.

As shown in Step b in FIG. 1 and FIGS. 6 to 9, in Step b, a formation process is performed on a surface of a second plate 2 to form a plurality of second conical rings 21 and a plurality of second attachment rings 22. The second plate 2 can be a plate made of a metal material of stainless steel, copper alloy, aluminum alloy, magnesium alloy, aluminum-magnesium alloy etc. or a plastic material of PC, ABS, PP etc. In addition, the aforementioned formation process can be achieved by the rolling, impacting, laser or in-mold formation method etc.

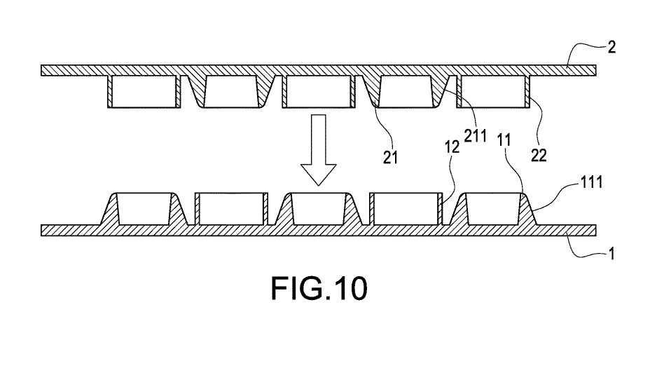

As shown in Step c and FIG. 10, in Step c, the second plate 2 is stacked onto the first plate 1, wherein each one of the first conical rings 11 is arranged to stack onto each one of the second attachment rings 22, and each one of the second conical rings 21 is arranged to stack onto each one of the first attachment rings 12.

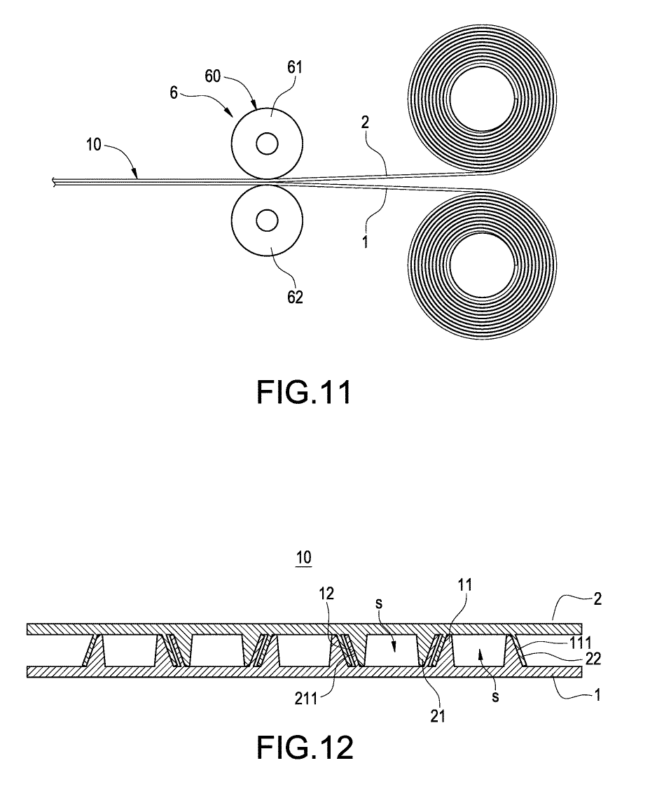

As shown in Step d and FIGS. 11 to 12, in Step d, a pressing device 6 is used to perform press process on the first plate 1 and the second plate 2 n order to allow each one of the first conical rings 11 and each one of the second attachment rings 22 to be inserted onto each other for attachment as well as to allow each one of the second conical rings 21 and each one of the first attachment rings 12 to be inserted onto each other for attachment

The following provides further detailed descriptions. The pressing device 6 can be a pressing mold or a roller assembly 60, wherein the roller assembly 60 comprises an upper roller 61 and a lower roller 62 arranged directly underneath the upper roller 61, wherein the press process can be performed in cold or hot formation method. After completing the aforementioned stacking operation on the first plate 1 and the second plate 2, they are delivered into the roller assembly for the rolling process between the upper roller 61 and the lower roller 62. Then, after the pressing by each rollers 61 and 62, each one of the first conical rings 11 is inserted into each of the second attachment rings 22 and gradually expands each one of the second attachment rings 22 outward in order to allow each one of the first conical rings 11 and each one of the second attachment rings 22 to form a press-fitted riveting structure for attachment between the two; each one of the second conical rings 21 is inserted into each of the first attachment rings 12 and gradually expands each one of the first attachment rings 12 outward in order to allow each one of the second conical rings 21 and each one of the first attachment rings 12 to form a press-fitted riveting structure for attachment between the two. In addition, a hollow cavity S is respectively formed between each one of the first conical rings 11 and each one of the second attachment rings 22 as well as between each one of the second conical rings 21 and each one of the first attachment rings 12.

Furthermore, the circumferential dimension of each one of the first conical rings 11 gradually increases toward the direction of the first plate 1 in order to allow each one of the first conical rings 11 to be able to insert into the second attachment rings 22 easily in order to form the press-fitted riveting structure. The circumferential dimension of each one of the second conical rings 21 gradually increases toward the direction of the second plate 2 in order to allow each one of the second conical rings 21 to be able to insert into the first attachment rings 12 easily in order to form the press-fitted riveting structure. Since the first plate 1 and the second plate 2 merely utilizes the insertion attachment method for forming the composite hollow board structure 10, the manufacturing step of bonding or welding adopted in the traditional method is omitted; consequently, the deformation capacity with bending resistance of the composite hollow board structure 10 is improved. As a result, the composite hollow board structure 10 is able to withstand vibrations, impacts and thermal expansion and contraction such that the overall strength and integrity of the entire structure can be maintained.

Moreover, each one of the first conical rings 11 is inserted into each one of the second attachment rings 22 and gradually expands each one of the second attachment rings 22 outward; each one of the second conical rings 21 is inserted into each one of the first attachment rings 12 and gradually expands each one of the first attachment rings 12 outward. Based on such configuration, the problem caused by gaps generated due to difficulties in the plasticity flow path during the flowing process of the first plate 1 and the second plate 2 can be overcome; therefore, the attachment strength of the first plate 1 and the second plate 2 can be increased.

In addition, the manufacturing process of the present invention can be applied to rapid mass production with significant reduction of costs, and the composite hollow board structure 10 of the present invention can undergo numerous times of rolling processes during the manufacturing such that the finished product manufactured can have numerous advantageous properties of slim, light weight, pressure resistance, excellent deformation capacity for bending, high toughness, appealing appearance and facilitated formation and manufacturing etc.

As shown in FIG. 2 to FIG. 12, the aforementioned manufacturing process can be utilized to manufacture a composite hollow board structure 10, which mainly comprises a first plate 1 and a second plate 2.

As shown in FIG. 2 to FIG. 5, a first surface of the first plate 1 is includes a plurality of first conical rings 11 and a plurality of first attachment rings 12 formed thereon; wherein each one of the first conical rings 11 includes a first outer circumferential wall 111.

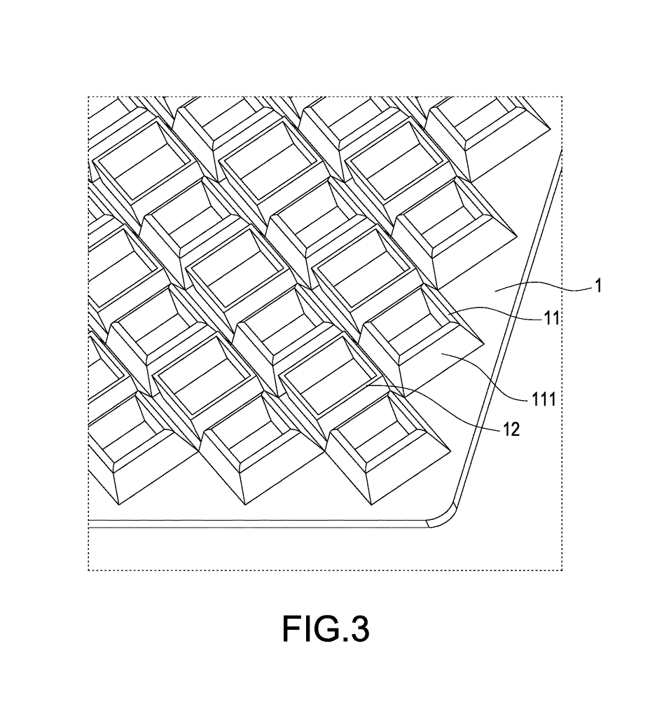

Furthermore, each one of the first conical rings 11 and each one of the first attachment rings 12 are arranged alternatively and aligned in rows adjacent to each other. The following provides further details. As shown in FIGS. 3 and 4, the perimeter of each one of the first conical rings 11 includes the first conical rings 11 and the first attachment rings 12 arranged alternatively, and the perimeter of each one of the first attachment rings 12 includes the first conical rings 11 and the first attachment rings 12 arranged alternatively; therefore, each one of the first conical rings 11 and each one of the first attachment rings 12 are arranged alternatively and aligned in rows adjacent to each other. Moreover, each one of the first conical rings 11 can be of a quadrilateral shape of rhombus shape or square shape etc.

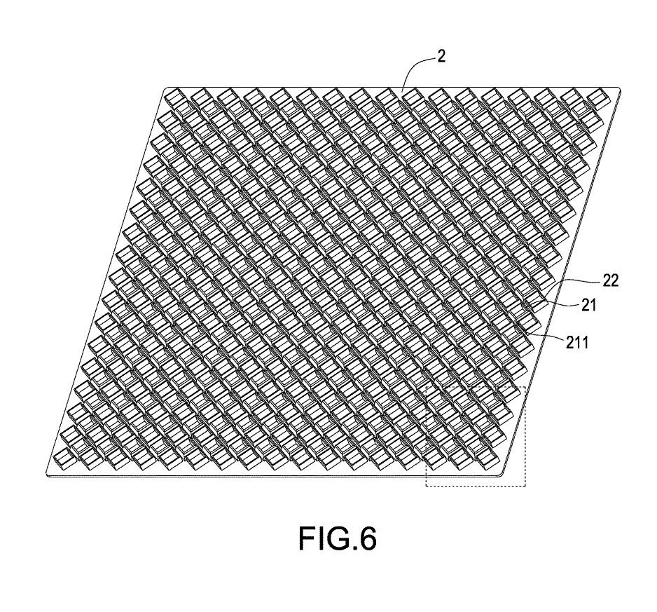

As shown in FIG. 6 to FIG. 9, the second plate 2 is pressed onto the first plate 1. A first surface of the second plate 2 is includes a plurality of second conical rings 21 and a plurality of second attachment rings 22 formed thereon; wherein each one of the second conical rings 21 includes a second outer circumferential wall 211, and each one of the second attachment rings 22 is press-fitted onto each one of the first outer circumferential wall 111 in order to allow each one of the first conical rings 11 to be inserted into each one of the second attachment rings 22 for attachment between the two; each one of the first attachment rings 12 is press-fitted onto each one of the second outer circumferential wall 211 in order to allow each one of the second conical rings 21 to be inserted into each one of the first attachment rings 12 for attachment between the two.

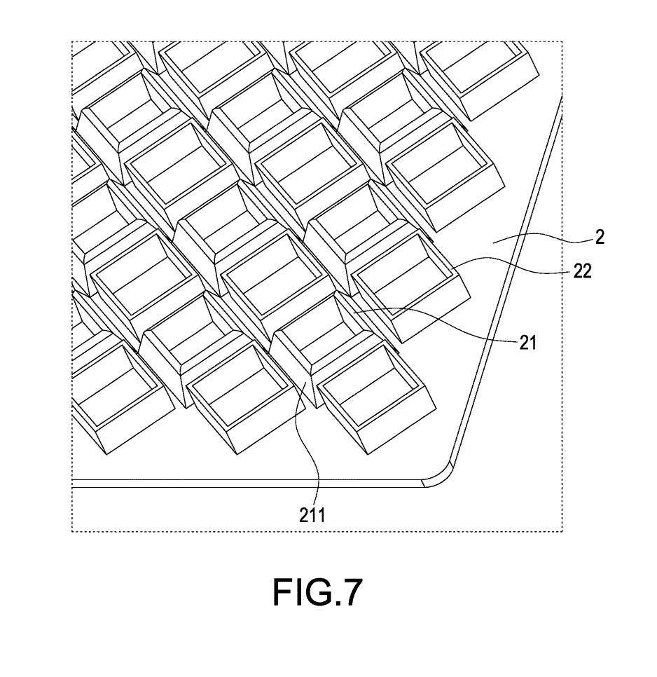

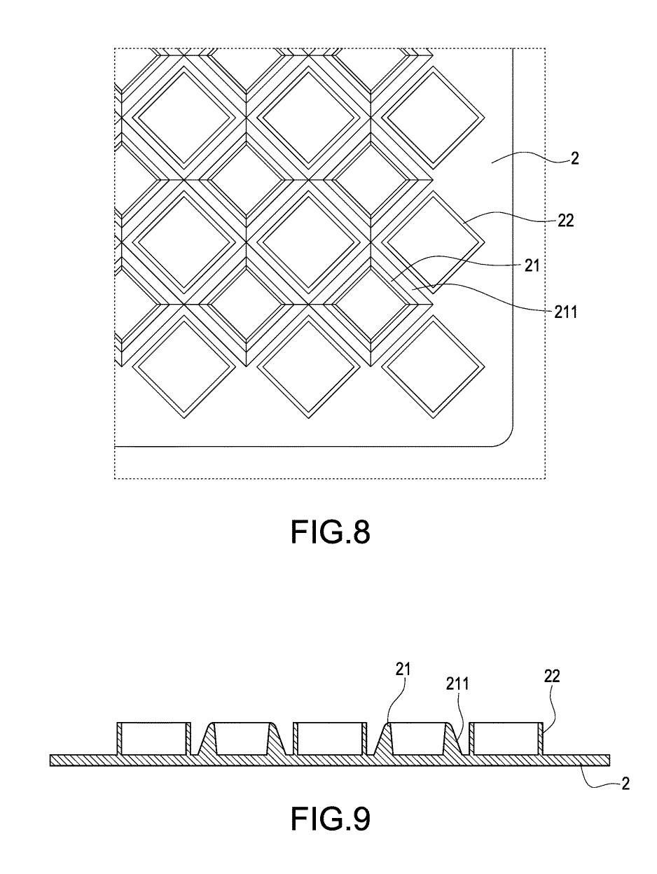

Furthermore, each one of the second conical rings 21 and each one of the second attachment rings 22 are arranged alternatively and aligned in rows adjacent to each other. The following provides further details. As shown in FIGS. 7 and 8, the perimeter of each one of the second conical rings 21 includes the second conical rings 21 and the second attachment rings 22 arranged alternatively, and the perimeter of each one of the second attachment rings 22 includes the second conical rings 21 and the second attachment rings 22 arranged alternatively; therefore, each one of the second conical rings 21 and each one of the second attachment rings 22 are arranged alternatively and aligned in rows adjacent to each other. In addition, each one of the second conical rings 21 can be of a quadrilateral shape of rhombus shape or square shape etc.

Moreover, the shape of each second attachment rings 22 matches with the shape of the first conical rings 11; in other words, the shape of the second attachment rings 22 can be identical to the shape of the first conical rings 11 as the quadrilateral shape of rhombus or square etc. Similarly, the shape of each first attachment rings 12 matches with the shape of the second conical rings 21; in other words, the shape of the first attachment rings 12 can be identical to the shape of the second conical rings 21 as the quadrilateral shape of rhombus or square.

As shown in FIG. 12, an assembly of the composite hollow board structure 10 of the present invention utilizes the design of a first plate 1 having a surface formed of a plurality of first conical rings 11 and a plurality of attachment rings 12 thereon; a second plate 2 is pressed onto the first plate 1, and the second plate 2 having a surface formed a plurality of second conical rings 21 and a plurality of second attachment rings 22 thereon; each one of the first conical rings 11 and each one of the second attachment rings 22 are inserted onto each other for attachment between the two, and each one of the second conical rings 21 and each one of the first attachment rings 12 are inserted onto each other for attachment between the two; in addition, a hollow cavity s is respectively formed between each one of the first conical rings 11 and each one of the second attachment rings 22 as well as between each one of the second conical rings 21 and each one of the first attachment rings 12. According to such structure, each one of the first attachment rings 12 and each one of the second outer circumferential wall 211 form a press-fitted riveting structure for insertion attachment in order to achieve the creation of the composite hollow board structure 10 formed by the first plate 1 and the second plate 2 inserted and attached onto each other. Since a plurality of hollow cavities s are formed between the first plate 1 and the second plate 2, the composite hollow board structure 10 is of the merits of light weight and pressure resistance. In addition, the composite hollow board structure 10 does not involve the known step of bonding or welding in the traditional method, it is able to increase the deformation capacity of bending with simplified manufacturing process and reduced manufacturing time.

Furthermore, each one of the first conical rings 11 can be of a polygonal shape of such as triangle, quadrilateral or hexagonal etc., and each one of the second conical rings 21 can be of a polygonal shape of such as triangle, quadrilateral or hexagonal etc.; however, present invention is not limited to such embodiment only. The shape of the second attachment ring 22 can be identical with the shape of the first conical ring 11 as a polygonal shape of triangle, quadrilateral or hexagonal. The shape of the first attachment ring 12 can be identical with the shape of the second conical ring 21 as a polygonal shape of triangle, quadrilateral or hexagonal.

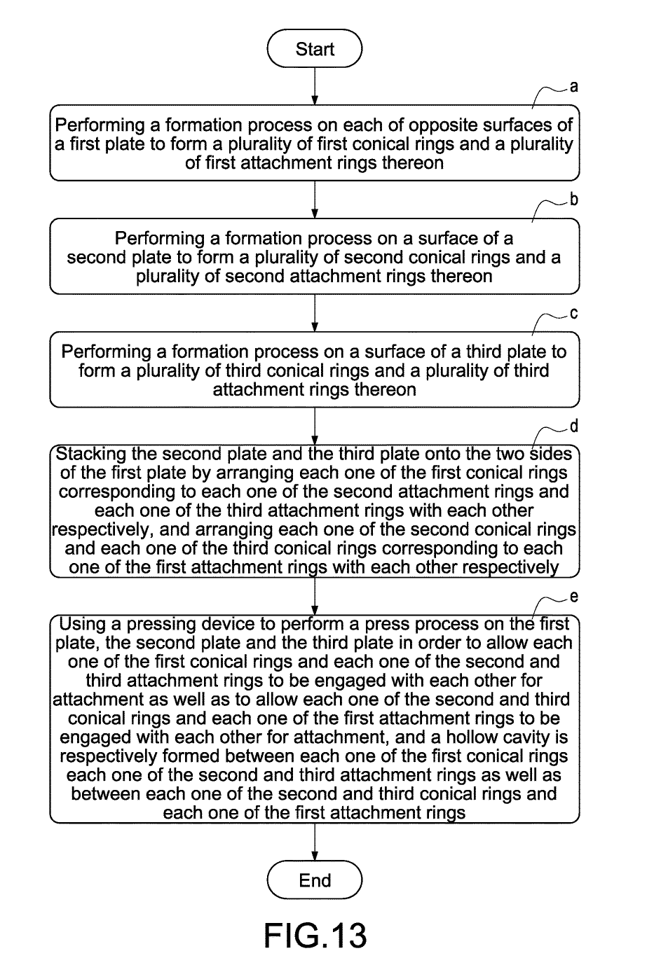

Please refer to FIGS. 13 to 15, showing another embodiment of a composite hollow board structure 10 and a manufacturing process thereof of the present invention. The embodiment shown in FIGS. 13 to 15 is generally identical to the embodiment shown in FIGS. 1 to 12, and the difference between the embodiment shown in FIGS. 13 to 15 and the embodiment shown in FIGS. 1 to 12 relies in that the composite hollow board structure 10 and the manufacturing method further comprises a third plate 3.

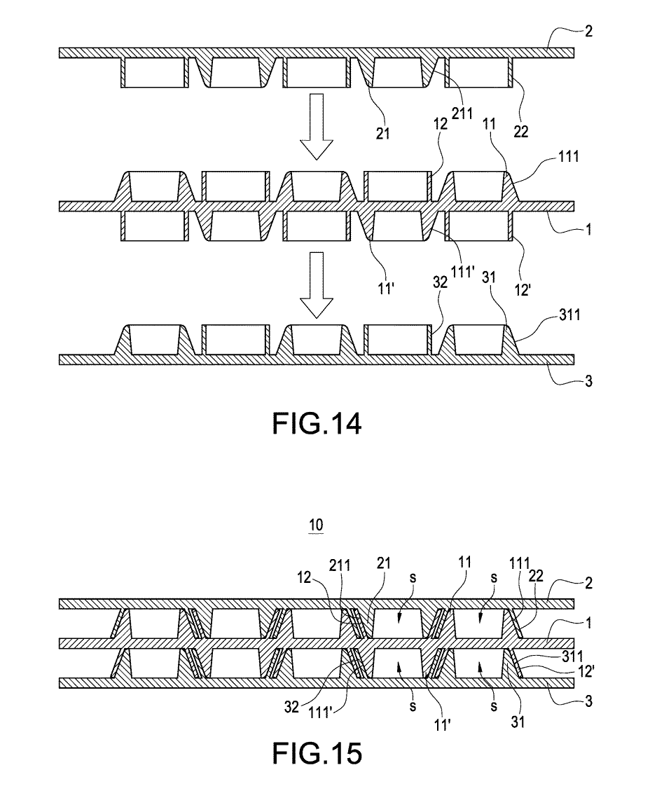

As shown in steps e, f, g and h in FIG. 13 and FIG. 14, in Step e, a formation process is performed on two opposite surfaces of the first plate 1 to form a plurality of first conical rings 11, 11′ and a plurality of first attachment rings 12, 12′. In Step f, a formation process is performed on a surface of the second plate 2 to form a plurality of second conical rings 21 and a plurality of second attachment rings 22. In Step g, a formation process is performed on a surface of a third plate 3 to form a plurality of third conical rings 31 and a plurality of third attachment rings 32. In Step h, the second plate 2 and the third plate 3 are stacked onto the two sides of the first plate 1 respectively. Each one of the first conical rings 11, 11′ is arranged to stack onto each one of the second attachment rings 22 and each one of the third attachment rings 32 respectively, and each one of the second conical rings 21 and each one of the third conical rings 31 are arranged to stack onto each one of the first attachment rings 12, 12′.

As shown in Step i in FIG. 13 and FIG. 15, a pressing device (referring to the pressing device 6 in FIG. 11) is used to perform press process on the first plate 1, the second plate 2 and the third plate 3 in order to allow each one of the first conical rings 11 to be inserted and attached onto each one of the second attachment rings 22, each one of the first conical rings 11′ is inserted and attached onto each one of the third attachment rings 32, each one of the second conical rings 21 is inserted and attached onto each one of the first attachment rings 12, and each one of the third conical rings 31 is inserted and attached onto each one of the first attachment rings 12′. In addition, a hollow cavity s is respectively formed between each one of the first conical rings 11 and each one of the second attachment rings 22, between each one of the first conical rings 11′ and each one of the third attachment rings 32, between each one of the second conical rings 21 and each one of the first attachment rings 12 as well as between each one of the third conical rings 31 and each one of the first attachment rings 12′.

The following provides further details. Each one of the first conical rings 11, 11′ is inserted into each one of the second attachment rings 22 and each one of the third attachment rings 32, which also gradually expands each one of the second attachment rings 22 and each one of the third attachment rings 32 outward in order to allow each one of the first conical rings 11, 11′ to form a press-fitted riveting structure with each one of the second attachment rings 22 and each one of the third attachment rings 32 for insertion and attachment between the parts. Similarly, each one of the second conical rings 21 and each one of the third conical rings 31 is inserted into each one of the first attachment rings 12, 12′, which also gradually expands each one of the first attachment rings 12, 12′ outward in order to allow each one of the second conical rings 21 and each one of the third conical rings 31 to form a press-fitted riveting structure with each one of the first attachment rings 12, 12′ for insertion and attachment between the parts.

Please refer to FIG. 15. The composite hollow board structure 10 manufactured by the aforementioned manufacturing process mainly comprises a firs plate 1, a second plate 2 and a third plate 3. A formation process is performed on another surface of the first plate 1 to form a plurality of first conical rings 11′ and a plurality of first attachment rings 12′. The second plate 2 and the third plate 3 are respectively pressed onto the two sides of the first plate 1. The third plate 3 includes a surface formed of a plurality of third conical rings 31 and a plurality of third attachment rings 32 thereon. Each one of the first conical rings 11′ and each one of the third attachment rings 32 are inserted onto each other for attachment between the two, and each one of the third attachment rings 31 and each one of the first attachment rings 12′ are inserted onto each other for attachment between the two. In addition a hollow cavity s is respectively formed between each one of the first conical rings 11′ and each one of the third attachment rings 32 as well as between each one of the third conical rings 31 and each one of the first attachment rings 12′. Accordingly, it is able to achieve the functions and effects identical to the ones of the embodiment shown in FIGS. 1 to 12.

In addition, each one of the first conical rings 11′ includes a first outer circumferential wall 111′, and each one of the third conical rings 31 includes a third outer circumferential wall 311′. Each one of the first attachment rings 12′ is press fitted onto each one of the third outer circumferential walls 311′, and each one of the third attachment rings 32 is press-fitted onto each one of the first outer circumferential walls 111, 111′.

Furthermore, the third plate 3 can be a plate made of a metal material of stainless steel, copper alloy, aluminum alloy, magnesium alloy, aluminum-magnesium alloy etc. or a plastic material of PC, ABS, PP etc. In addition, the second plate 2 and the third plate 3 can be of the same or different materials.

Moreover, each one of the first conical rings 11′ and each one of the first attachment rings 12′ are arranged alternatively and aligned in rows adjacent to each other. Each one of the third conical rings 31 and each one of the third attachment rings 32 are arranged are arranged alternatively and aligned in rows adjacent to each other.

In addition, each one of the first conical rings 11′ can be of a polygonal shape of such as triangle, quadrilateral or hexagonal etc., and each one of the third attachment rings 32 can be of a shape matching with the shape of the first conical rings 11′. Each one of the third conical rings 31 can be of a polygonal shape of such as triangle, quadrilateral or hexagonal etc., each one of the first attachment rings 12′ can be of a shape matching with the shape of the second conical rings 21.

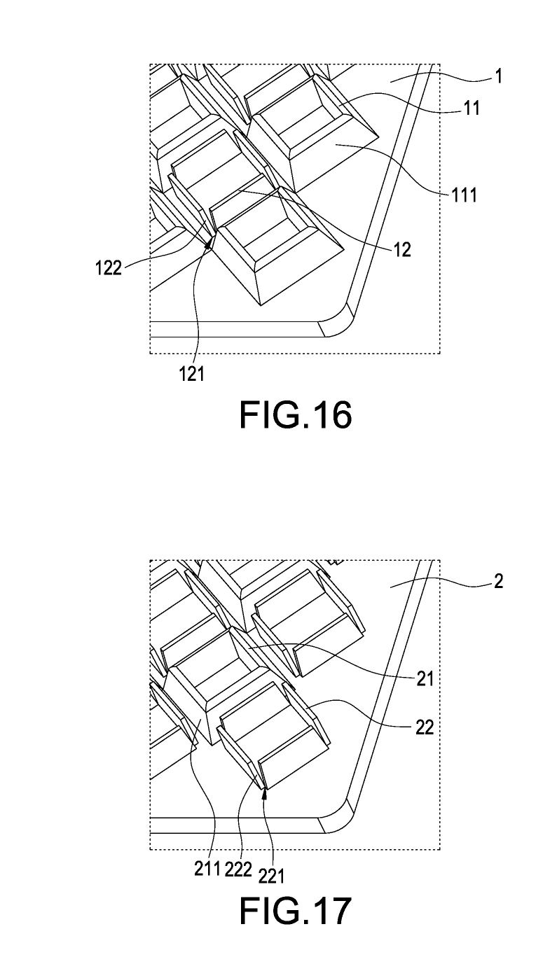

Please refer to FIGS. 16 to 17, showing another embodiment of the first plate 1 and the second plate 2 of the present invention. The embodiment shown in FIGS. 16 to 17 is generally identical to the embodiment shown in FIGS. 2 to 12; and the difference between the embodiment shown in FIGS. 16 to 17 and the embodiment shown in FIGS. 2 to 12 relies in that each one of the first attachment rings 12 includes a plurality of first opening slots 122 formed thereon, and each one of the second attachment rings 22 includes a plurality of second opening slots 222.

The following provides further details. Each one of the first conical rings 12 can be of a polygonal shape of triangle, quadrilateral or hexagonal, which includes a plurality of first corners 121. Each one of the first corners 121 includes a first opening slot 122 formed to extend from the top portion to the bottom portion thereof, and each one of the first opening slot 122 refers to a conical slot tapered from the top portion of the first corner 121 toward the direction of the bottom portion with a reduced aperture.

Furthermore, each one of the second conical rings 22 can be of a polygonal shape of triangle, quadrilateral or hexagonal, which includes a plurality of second corners 221. Each one of the second corners 221 includes a second opening slot 222 formed to extend from the top portion to the bottom portion thereof, and each one of the second opening slot 222 refers to a conical slot tapered from the top portion of the second corner 221 toward the direction of the bottom portion with a reduced aperture.

Accordingly, when each one of the first conical rings 11 is inserted and attached onto each one of the second attachment rings 22 respectively and when each one of the second conical rings 21 is inserted and attached onto each one of the first attachment rings 12 respectively, the outward expansion force exerted on the second attachment rings 22 by the first conical rings 11 can be released via the second opening slot 222, and the outward expansion force exerted on the first attachment rings 12 by the second conical rings 21 can be released via the first opening slot 122 in order to prevent the first attachment rings 12 and the second attachment rings 22 from ruptures due to excessive outward expansion forces.

Moreover, a preferred embodiment of the first opening slot 122 and the second opening slot 222 is a conical slot such that it matches with the shape of the first conical rings 11 and the second conical rings 21 most appropriately. Nevertheless, the shape of the first opening slots 122 an the second opening slots 222 can be other shapes such that it is not limited to the example of conical shape. Similarly, as shown in FIG. 14, to prevent the first attachment rings 12′ and the third attachment rings 32 from ruptures due to excessive outward expansion forces, the corner areas of the first attachment rings 12′ and the third attachment rings 32 can also be formed with opening slots extending from the top portion to the bottom portion respectively.

The above is provided to describe the preferred embodiments of the present invention, which shall not be treated as limitations to the claims of the present invention. Other equivalent modifications utilizing the spirit of the patent of the present invention shall all be deemed to be within the scope of the claims of the present invention.

What is claimed is:

1. A manufacturing method for a composite hollow board structure, comprising the steps of:
a) performing a formation process on a surface of a first plate to form a plurality of first conical rings and a plurality of first attachment rings thereon;
b) performing a formation process on a surface of a second plate to form a plurality of second conical rings and a plurality of second attachment rings thereon;
c) stacking the second plate onto the first plate by arranging each one of the first conical rings corresponding to each one of the second attachment rings with each other respectively, and arranging each one of the second conical rings corresponding to each one of the first attachment rings with each other respectively; and
d) using a pressing device to perform a press process on the first plate and the second plate in order to allow each one of the first conical rings and each one of the second attachment rings to be engaged with each other for attachment as well as to allow each one of the second conical rings and each one of the first attachment rings to be engaged with each other for attachment, and a hollow cavity is respectively formed between each one of the first conical rings and each one of the second attachment rings as well as between each one of the second conical rings and each one of the first attachment rings.

2. The manufacturing method for a composite hollow board structure according to claim 1, wherein in step d), each one of the first conical rings is inserted into each one of the second attachment rings and expands each one of the second attachment rings outward; each one of the second conical rings is inserted into each one of the first attachment rings and expands each one of the first attachment rings outward.

3. The manufacturing method for a composite hollow board structure according to claim 1, wherein in step a) or step b), the formation process refers to a rolling, an impacting, a laser or an in-mold formation.

4. A manufacturing method for a composite hollow board structure, comprising the steps of:
a) performing a formation process on each of opposite surfaces of a first plate to form a plurality of first conical rings and a plurality of first attachment rings thereon;
b) performing a formation process on a surface of a second plate to form a plurality of second conical rings and a plurality of second attachment rings thereon;
c) performing a formation process on a surface of a third plate to form a plurality of third conical rings and a plurality of third attachment rings thereon;
d) stacking the second plate and the third plate onto the two sides of the first plate by arranging each one of the first conical rings corresponding to each one of the second attachment rings and each one of the third attachment rings with each other respectively, and arranging each one of the second conical rings and each one of the third conical rings corresponding to each one of the first attachment rings with each other respectively; and
e) using a pressing device to perform a press process on the first plate, the second plate and the third plate in order to allow each one of the first conical rings and each one of the second and third attachment rings to be engaged with each other for attachment as well as to allow each one of the second and third conical rings and each one of the first attachment rings to be engaged with each other for attachment, and a hollow cavity is respectively formed between each one of the first conical rings and each one of the second and third attachment rings as well as between each one of the second and third conical rings and each one of the first attachment rings.

5. The manufacturing method for a composite hollow board structure according to claim 4, wherein in step e) each one of the first conical rings is inserted into each one of the second and third attachment rings and expands each one of the second and third attachment rings outward; each one of the second and third conical rings is inserted into each one of the first attachment rings and expands each one of the first attachment rings outward.

6. The manufacturing method for a composite hollow board structure according to claim 4, wherein in step a), step b) or step c), the formation process refers to a rolling, an impacting, a laser or an in-mold formation.

7. A composite hollow board structure, comprising:
a first plate having a surface formed of a plurality of first conical rings and a plurality of first attachment rings thereon; and
a second plate pressed onto the first plate and having a surface formed a plurality of second conical rings and a plurality of second attachment rings thereon; and
wherein each one of the first conical rings and each one of the second attachment rings are engaged with each other for attachment, each one of the second conical rings and each one of the first attachment rings are engaged with each other for attachment; wherein a hollow cavity is respectively formed between each one of the first conical rings and each one of the second attachment rings as well as between each one of the second conical rings and each one of the first attachment rings.

8. The composite hollow board structure according to claim 7, wherein each one of the first conical rings includes a first outer circumferential wall, and each one of the second conical ring includes a second outer circumferential wall; wherein each one of the first attachment rings is attached onto each one of the second outer circumferential wall via a press-fitting method, and each one of the second attachment rings is attached onto each one of the first outer circumferential wall via a press-fitting method.

9. The composite hollow board structure according to claim 7, wherein each one of the first conical rings and each one of the first attachment rings are arranged alternatively and aligned in rows adjacent to each other, and each one of the second conical rings and each one of the second attachment rings are arranged alternatively and aligned in rows adjacent to each other.

10. The composite hollow board structure according to claim 9, wherein each one of the first conical rings is of a shape of one of triangular, quadrilateral or hexagonal shape, and each one of the second attachment rings is of a shape matching with the shape of the first conical rings; wherein each one of the second conical rings is of a shape of one of triangular, quadrilateral or hexagonal shape, and each one of the first attachment rings is of a shape matching with the shape of the second conical rings.

11. The composite hollow board structure according to claim 9, wherein each one of the first attachment rings is of a polygonal shape with a plurality of first corners, and each one of the first corners includes a first opening slot formed from to extend from a top portion to a bottom portion; wherein each one of the second attachment rings is of a polygonal shape with a plurality of second corners, and each one of the second corners includes a second opening slot formed from to extend from a top portion to a bottom portion.

12. The composite hollow board structure according to claim 11, wherein each one of the first opening slots is a conical slot tapered from the top portion of the first corner toward the direction of a bottom portion with a reduced aperture; wherein each one of the second opening slots is a conical slot tapered from the top portion of the second corner toward a direction of the bottom portion with a reduced aperture.

13. The composite hollow board structure according to claim 7, wherein the first plate is made of a metal or a plastic material, and the second plate is made of a metal or a plastic material.

14. The composite hollow board structure according to claim 7, further comprising a third plate having a surface formed of a plurality of third conical rings and a plurality of third attachment rings thereon, and another side of the first plate further comprising the plurality of first conical rings and the plurality of first attachment rings formed thereon; wherein the second plate and the third plate are pressed onto two sides of the first plate respectively; each one of the first conical rings and each one of the third attachment rings are inserted onto each other for attachment, each one of the third conical rings and each one of the first attachment rings are inserted onto each other for attachment; and a hollow cavity is respectively formed between each one of the first conical rings and each one of the third attachment rings as well as between each one of the third conical rings and each one of the first attachment rings.

15. The composite hollow board structure according to claim 14, wherein the first plate is made of a metal or a plastic material, the second plate is made of a metal or a plastic material, and the third plate is made of a metal or a plastic material; and wherein the second plate and the third plate are of identical or different materials.

16. The composite hollow board structure according to claim 14, wherein each one of the first conical rings includes a first outer circumferential wall, each one of the second conical ring includes a second outer circumferential wall, and each one of the third conical ring includes a third outer circumferential wall; wherein each one of the first attachment rings is attached onto each one of the second and third outer circumferential wall via a press-fitting method, and ach one of the second and third attachment rings is attached onto each one of the first outer circumferential wall via a press-fitting method.

17. The composite hollow board structure according to claim 14, wherein each one of the first conical rings and each one of the first attachment rings are arranged alternatively and aligned in rows adjacent to each other, each one of the second conical rings and each one of the second attachment rings are arranged alternatively and aligned in rows adjacent to each other, and each one of the third conical rings and each one of the third attachment rings are arranged alternatively and aligned in rows adjacent to each other.

18. The composite hollow board structure according to claim 17, wherein each one of the first conical rings is of a shape of one of triangular, quadrilateral or hexagonal shape, and each one of the second and third attachment rings is of a shape matching with the shape of the first conical rings; wherein each one of the second and third conical rings is of a shape of one of triangular, quadrilateral or hexagonal shape, and each one of the first attachment rings is of a shape matching with the shape of the second conical rings.
